(19) United States
(12) Patent Application Publication
(10) Pub. No.: US 2026/0330588 A1
(43) Pub. Date: Oct. 22, 2026

(54) CUSTOM RESOLVE PASS OUT OF BOUNDS PREVENTION

(71) Applicant: QUALCOMM Incorporated, San Diego, CA (US)

(72) Inventors: Maxime DESCOS, San Diego, CA (US); Brian ELLIS, San Diego, CA (US); Ashokanand NEELAMBARAN, San Diego, CA (US); Mohit SADAYET, Bangalore (IN)

(21) Appl. No.: 19/181,178

(22) Filed: Apr. 16, 2025

(51) Int. Cl. G06T 1/20; G06F 3/01; G06T 15/80

(52) U.S. Cl. CPC G06T 1/20; G06F 3/013; G06T 15/80

(57) ABSTRACT

This disclosure provides systems, devices, apparatus, and methods, including computer programs encoded on storage media, for enabling window scissors for multiple views of a primitive. A graphics processor may obtain a foveation identifier associated with an eye focus and a set of coordinates associated with a view of a primitive. The graphics processor may select a window scissor from a plurality of window scissors based on the obtained foveation identifier. The graphics processor may modify the set of coordinates associated with the view of the primitive based on the selected window scissor. The graphics processor may output the modified set of coordinates.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address window scissoring techniques for multi-view scenarios without sacrificing functionality. There is a need for improved multi-view window scissoring techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and a set of processors coupled to the memory and, based at least in part on information stored in the memory, the set of processors may be configured to obtain a foveation identifier associated with an eye focus and a set of coordinates associated with a view of a primitive. The set of processors may be configured to select a window scissor from a plurality of window scissors based on the obtained foveation identifier. The set of processors may be configured to modify the set of coordinates associated with the view of the primitive based on the selected window scissor. The set of processors may be configured to output the modified set of coordinates.

In some aspects, the techniques described herein relate to a method of graphics processing, including: obtaining a foveation identifier associated with an eye focus and a set of coordinates associated with a view of a primitive; selecting a window scissor from a plurality of window scissors based on the obtained foveation identifier; modifying the set of coordinates associated with the view of the primitive based on the selected window scissor; and outputting the modified set of coordinates.

In some aspects, the techniques described herein relate to a method, further including: obtaining the output modified set of coordinates at a shader of a graphics processor; and rendering, at the shader, the view of the primitive based on the obtained modified set of coordinates.

In some aspects, the techniques described herein relate to a method where obtaining the foveation identifier and the set of coordinates includes: obtaining the foveation identifier and the set of coordinates from a graphics driver.

In some aspects, the techniques described herein relate to a method, where selecting the window scissor from the plurality of window scissors based on the obtained foveation identifier includes: selecting, at a triangle setup engine (TSE) of a graphics processor, the window scissor from the plurality of window scissors, where each window scissor of the plurality of window scissors is associated with a view of a plurality of views of the primitive.

In some aspects, the techniques described herein relate to a method, where modifying the set of coordinates associated with the view of the primitive based on the selected window scissor includes: modifying, at a triangle setup engine (TSE) of a graphics processor, the set of coordinates associated with the view of the primitive based on the selected window scissor.

In some aspects, the techniques described herein relate to a method, where the graphics processor includes a graphics processing unit (GPU).

In some aspects, the techniques described herein relate to a method, further including: determining the plurality of views of the primitive based on six primary views of the primitive in space; and determining each window scissor of the plurality of window scissors based on the determined plurality of views before the selection of the window scissor from the plurality of window scissors.

In some aspects, the techniques described herein relate to a method, where determining each window scissor of the plurality of window scissors based on the determined plurality of views includes: determining each window scissor of the plurality of window scissors further based on a set of use cases associated with the six primary views of the primitive in space.

In some aspects, the techniques described herein relate to a method, further including: obtaining a second foveation identifier associated with a second eye focus and a second set of coordinates associated with a second view of the primitive, where the eye focus is associated with a first eye of a user and the second eye focus is associated with a second eye of the user; selecting a second window scissor from the plurality of window scissors based on the obtained second foveation identifier; modifying the second set of coordinates associated with the second view of the primitive based on the selected second window scissor; and outputting the modified second set of coordinates.

In some aspects, the techniques described herein relate to a method, where obtaining the foveation identifier associated with the eye focus and the set of coordinates associated with the view of the primitive includes: determining the set of coordinates based on at least one of: a foveation offset parameter; a shift to an edge of a view parameter; an apron parameter; or a merging parameter.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4A-4F illustrate examples of various views of a primitive, in accordance with one or more techniques of this disclosure.

FIG. 5 illustrates an example of a coordinate modification engine, in accordance with one or more techniques of this disclosure.

FIG. 6 is a call flow diagram illustrating example communications between a command processor (CP) and a triangle setup engine (TSE), in accordance with one or more techniques of this disclosure.

FIG. 7 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some aspects, an application, also referred to as an app, executed on an operating system may be configured to generate its own three-dimensional (3D) engine store pass through an extension of a graphics processor, for example a graphics processing unit (GPU). A 3D engine store pass may be a render pass of a bin that stores data to a buffer or a texture for use by another stage of a graphics pipeline. The GPU may treat the 3D engine store pass like a normal draw with the buffer location toggled to an off-chip memory, for example a system memory (SYSMEM) or an external memory. The GPU may be configured to fetch data from an on-chip memory, for example graphics memory (GMEM), process the fetched data via a graphics pipeline, and pass the data through a stage of the graphics pipeline to a shader provided by the app by resolving the data to the off-chip memory. This may also be referred to as a 3D engine store pass of the GPU, which resolves the data to the off-chip memory. In some aspects, the app may not know the specific foveated bin layout of a rendered resource passed to the 3D engine store pass. A foveated bin layout may include a layout that downscales a bin to reduce resolution and improve performance. In an aspect that renders resources for a virtual reality (VR) environment, a graphics processor may downscale a set of bins to reduce resolution and improve performance of rendering resources of the set of bins. The graphics processor may merge such comparatively smaller bins to improve utilization of on-chip memory (e.g., GMEM). In some aspects, the graphics processor may merge such bins by expanding a screen scissor of one bin to encompass a plurality of bins. In some aspects, the graphics processor may expand a window scissor for the merged bin to cover the surface and patch a set of screen scissors to keep a correct behavior. Patching a set of screen scissors may allow the graphics processor to retrieve original window scissor behavior and avoid out of bounds (OOB) access for each view of a primitive. A window scissor may include a set of coordinates that designate an area within which a stage of a graphics pipeline may render a primitive on a screen. If a primitive does not fit within the scissor, a shader may cut out the non-fitting portion of the primitive based on the scissor. In other words, the shader may refrain from rendering any portion of the primitive that falls outside of the window scissor. Screen scissors patching may involve resizing a screen scissor to match a modified view, for example a view that merges a plurality of downscaled bins.

In some aspects, a graphics processor may resolve bins via subsampling and shifting to allow room for aprons. The graphics processor may utilize fragment density map (FDM) offsets to shift the bin and improve foveation control. Each shift may be based on a view, as a first view of a primitive may have a different scaling from at least one other view of the same primitive. In some aspects, a driver of a graphics processor may be configured to define a single window scissor per bin. However, if a graphics driver defines a single window scissor per bin, but no more, than to accommodate multiple views (e.g., six views of the same primitive from the front, back, left, right, top, and bottom) of the same primitive, the graphics driver may be configured to have expanded functionality. For example, a graphics driver may use a software workaround to expand a windows scissor to the full surface of the primitive. However, doing so may result in an out of bounds location in the on-chip memory (e.g., GMEM), as such a broad scissor does not restrict access to surfaces of the primitive. In another aspect, a triangle setup engine (TSE) of a graphics pipeline may be configured to have a plurality of window scissors that each correspond with a different supported view (e.g., six window scissors for six supported views of a primitive). An enable bit may be used to indicate to the TSE that multiple window scissors for multiple views are designated for a primitive. The TSE may select a window scissor from a plurality of window scissors based on a foveation identifier (ID). The TSE may use the selected window scissor to perform window scissor clipping.

In some examples, a graphics processor (or graphics processor system) may obtain a foveation identifier (ID) associated with an eye focus and a set of coordinates associated with a view of a primitive. The foveation ID may also be referred to as the FovID or fovID, and may be used to identify a focal point where an eye, or a pair of eyes, are focused on a display. The set of coordinates may include coordinates that identify a view of a primitive to process during a pass, for example a binning pass or a rendering pass. The graphics processor may select a window scissor from a plurality of window scissors based on the obtained foveation identifier. The foveation ID may be associated with a view of the primitive, and the window scissor may be associated with the view of the primitive associated with the foveation ID. The graphics processor may modify the set of coordinates associated with the view of the primitive based on the selected window scissor. For example, the selected window scissor may exclude a portion of the set of coordinates associated with the view of the primitive. The graphics processor may exclude coordinates that fall outside of the boundaries of the selected window scissor, ensuring that an out of bounds condition does not occur when processing the modified set of coordinates. The graphics processor may output the modified set of coordinates.

In some aspects, to output the modified set of coordinates, the graphics processor may transmit the modified set of coordinates to a graphics processing engine. For example, the graphics processor may transmit the modified set of coordinates to a 3D engine store pass of an application. In some aspects, to output the modified set of coordinates, the graphics processor may store the modified set of coordinates to a second memory. For example, the graphics processor may store the modified set of coordinates to an external memory (e.g., SYSMEM). The graphics processor may obtain the output modified set of coordinates at a shader of a graphics processor. The shader may be a graphics stage of a graphics pipeline at the graphics processor, or in an application. The graphics processor may render, at the shader, the view of the primitive based on the obtained modified set of coordinates. For example, the shader may render the view of the primitive while excluding portions of the primitive that are excluded by the modified set of coordinates. To obtain the foveation identifier and the set of coordinates, the graphics processor may obtain the foveation identifier and the set of coordinates from a graphics driver. For example, an application may provide a FovID and a set of coordinates associated with a view of a primitive to a driver via an application programming interface (API), and the driver may then provide the FovID and the set of coordinates to the graphics processor. To select the window scissor from the plurality of window scissors based on the obtained foveation identifier, the graphics processor may select, at a triangle setup engine (TSE) of the graphics processor, the window scissor from the plurality of window scissors. The TSE may be a stage of a graphics pipeline of the graphics processor. Each window scissor of the plurality of window scissors may be associated with a corresponding view of a plurality of views of the primitive. To modify the set of coordinates associated with the view of the primitive based on the selected window scissor, the graphics processor may modify, at a TSE of the graphics processor, the set of coordinates associated with the view of the primitive based on the selected window scissor. The graphics processor may include a GPU. The graphics processor may determine the plurality of views of the primitive based on six primary views of the primitive in space. For example, a driver of the graphics processor may provide the number of views and how to select which one to render to. The graphics processor may determine each window scissor of the plurality of window scissors based on the determined plurality of views before the selection of the window scissor from the plurality of window scissors. In other words, each window scissor of the plurality of window scissors may correspond to a corresponding view of the plurality of views. Before selecting the window scissor, the graphics processor may define a window scissor for each of the primary six views of the primitive each space. A driver may calculate the coordinates of each window scissor for each of the number of views indicated by the driver. The graphics processor may be configured to loop through each of the number of views indicated by the driver, where each view is uniquely identified by a fovID. To determine each window scissor of the plurality of window scissors based on the determined plurality of views, the graphics processor may determine each window scissor of the plurality of window scissors further based on a set of use cases associated with the six primary views of the primitive in space. In other words, the graphics processor may select which scissor to use based on both the fovID and historical use cases of multiple views of a primitive. An application may be configured to indicate to a driver of the graphics processor a number of views to render of a primitive. In response, the driver may indicate one window scissor for each of the indicated number of views and pass the associated fovID to the graphics processor for each corresponding view. The graphics processor may obtain a second foveation identifier associated with a second eye focus and a second set of coordinates associated with a second view of the primitive. The eye focus may be associated with a first eye of a user and the second eye focus is associated with a second eye of the user. The graphics processor may select a second window scissor from the plurality of window scissors based on the obtained second foveation identifier. The graphics processor may modify the second set of coordinates associated with the second view of the primitive based on the selected second window scissor. The graphics processor may output the modified second set of coordinates. To obtain the foveation identifier associated with the eye focus and the set of coordinates associated with the view of the primitive, the graphics processor may determine the set of coordinates based on at least one of (a) a foveation offset parameter, (b) a shift to an edge of a view parameter, (c), an apron parameter, or (d) a merging parameter.

Particular aspects of the subject matter described in this disclosure can be implemented to realize one or more of the following potential advantages. In some examples, by enabling a TSE to apply a window scissor based on a selected view of a primitive, the described techniques can be used to efficiently support multi-view window scissoring.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

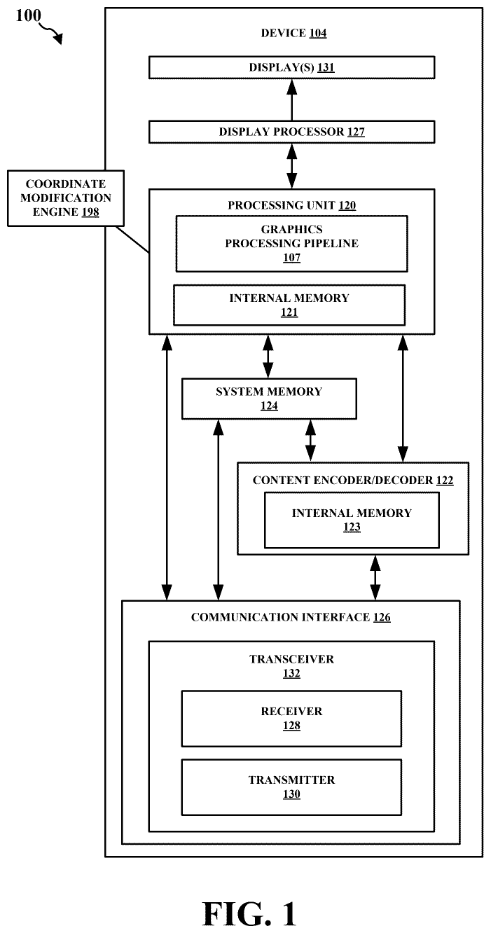

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device. The processing unit 120 may be a GPU.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a coordinate modification engine 198 configured to obtain a foveation identifier associated with an eye focus and a set of coordinates associated with a view of a primitive. The coordinate modification engine 198 may be configured to select a window scissor from a plurality of window scissors based on the obtained foveation identifier. The coordinate modification engine 198 may be configured to modify the set of coordinates associated with the view of the primitive based on the selected window scissor. The coordinate modification engine 198 may be configured to output the modified set of coordinates. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

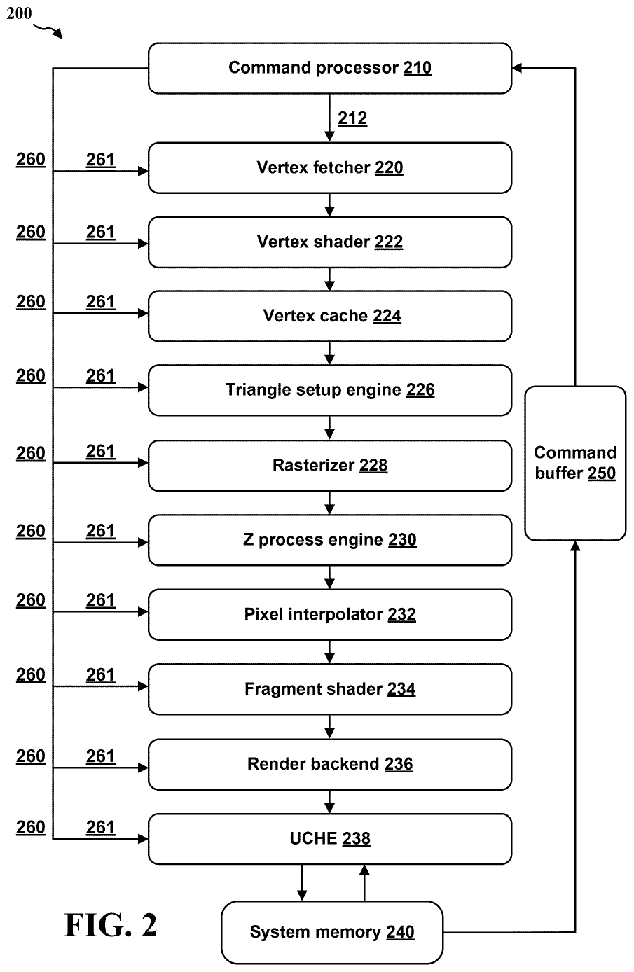

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

In some aspects, the TSE 226 may be configured to feed its output to the RAS 228, with the buffer location toggled to an off-chip memory (e.g., SYSMEM) for a 3D engine store pass of an application. In other aspects, the 3D engine store pass may fetch the output from the TSE 226 from an on-chip memory (e.g., GMEM), and use the shader provide by an application to process the fetched data. The shader used in the fragment shader of the 3D engine store pass may be provided by an application, such that the fragment is stored on the off-chip memory. In short, the TSE 226 may modify a set of coordinates associated with a view of a primitive based on a fovID that identifies the view of the primitive, and the modified set of coordinates may indicate where the fragments will be stored on the off-chip memory.

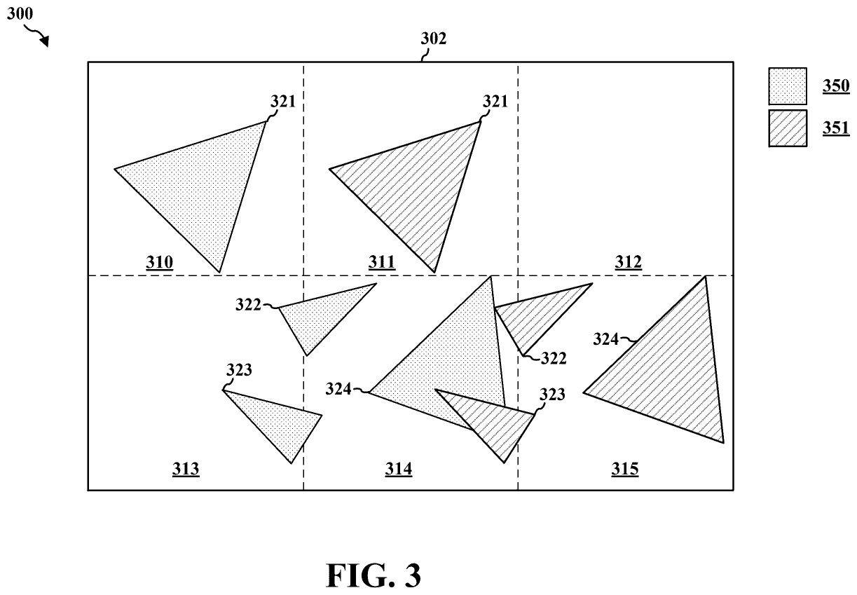

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

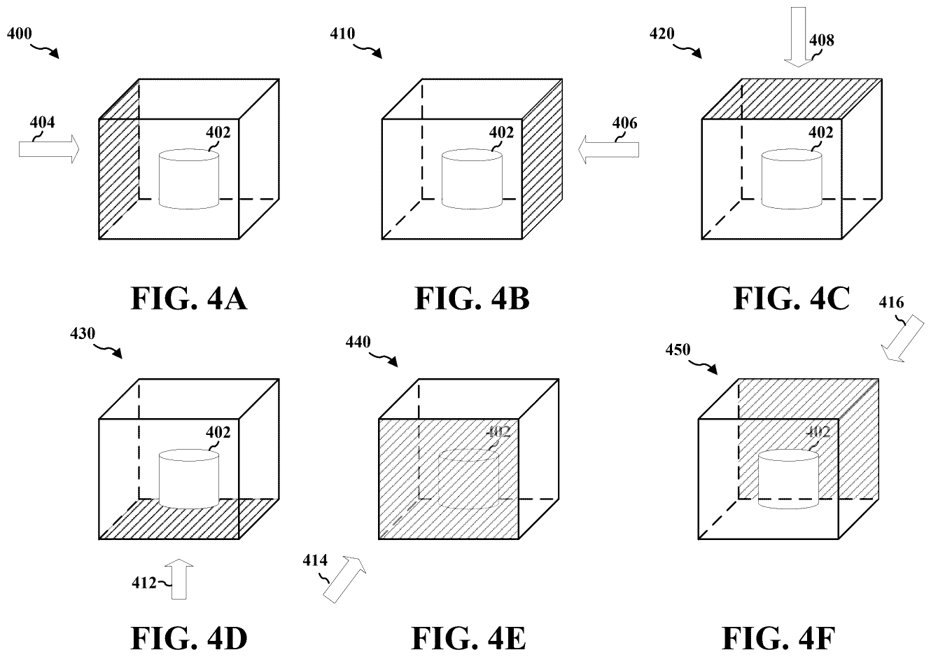

FIG. 4A-4F illustrate examples of various views of a primitive, in accordance with one or more techniques of this disclosure. The views represent six primary views of a primitive 402 in space. FIG. 4A is a diagram 400 of six primary views of the primitive 402 in space. A driver may indicate a FovID that indicates that an eye focus of a user is viewing the primitive 402 via a view 404 of the primitive 402 from a left side of the primitive 402. FIG. 4B is a diagram 410 of six primary views of the primitive 402 in space. A driver may indicate a FovID that indicates that an eye focus of a user is viewing the primitive 402 via a view 406 of the primitive 402 from a right side of the primitive 402. FIG. 4C is a diagram 420 of six primary views of the primitive 402 in space. A driver may indicate a FovID that indicates that an eye focus of a user is viewing the primitive 402 via a view 408 of the primitive 402 from a top side of the primitive 402. FIG. 4D is a diagram 430 of six primary views of the primitive 402 in space. A driver may indicate a FovID that indicates that an eye focus of a user is viewing the primitive 402 via a view 412 of the primitive 402 from a bottom side of the primitive 402. FIG. 4E is a diagram 440 of six primary views of the primitive 402 in space. A driver may indicate a FovID that indicates that an eye focus of a user is viewing the primitive 402 via a view 414 of the primitive 402 from a front side of the primitive 402. FIG. 4F is a diagram 450 of six primary views of the primitive 402 in space. A driver may indicate a FovID that indicates that an eye focus of a user is viewing the primitive 402 via a view 416 of the primitive 402 from a rear side of the primitive 402. In some aspects, the FovID may indicate one of the six primary views of a primitive, for example by indicating an integer from 0 to 5 to indicate which of the six primary views is selected.

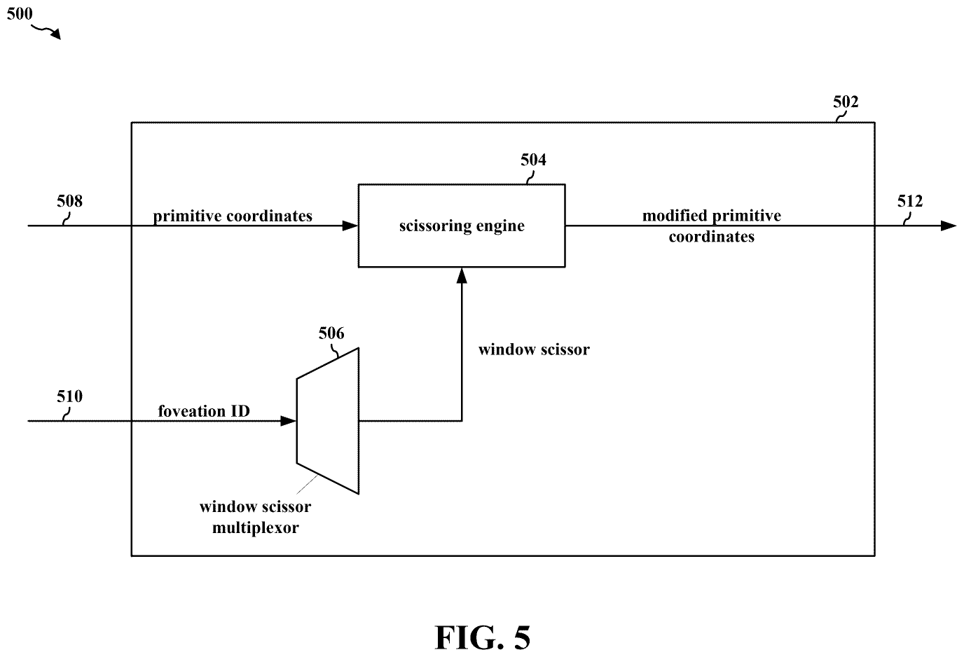

FIG. 5 is a diagram 500 of an example of a coordinate modification engine 502, in accordance with one or more techniques of this disclosure. The coordinate modification engine 502 may be implemented by a TSE of a graphics pipeline, such as the TSE 226 in FIG. 2.

A graphics processor may downscale a bin to reduce a resolution of the bin and improve performance. The location of the bin may be changed according to a number of parameters, for example a foveation offset, a shift to the edge, an apron, or a merge of a plurality of bins into a single bin. Each of these parameters may be view dependent. When resolving a bin, the graphics processor may know the exact location of the bin to avoid out of bounds access, however an application that generates its own 5D engine store pass may not know the exact location of a downscaled bin. When resolving a primitive with multiple views, each view may result in a different location per bin. While this may be resolved by expanding the window scissor to cover the entire surface of the primitive, this may result in out of bounds. While this also may be resolved by patching each view with a set of view-specific scissors to recover the original scissoring behavior, this may also be detrimental to performance due to patching. Moreover, if an app generates its own 5D engine store pass, the driver will be unable to patch the window scissor, as the app does not know the bin location, as the bin location may be dependent upon one of the aforementioned parameters (e.g., foveation offset).

The coordinate modification engine 502 may generate a plurality of window scissors of a primitive, one per primary view of the primitive, for a total of six primary views and six window scissors. The coordinate modification engine 502 may obtain an indicator 510 of a foveation ID, or a FovID. The FovID may also be used in other foveation and multiview use cases, for example to select which angle a user is viewing the primitive from. The window scissor multiplexor 506 may select a window scissor corresponding to the view selected by the FovID. The coordinate modification engine 502 may obtain an indicator 508 of a set of coordinates of a primitive for processing (e.g., in a render pass). The scissoring engine 504 may scissor the set of coordinates based on the selected window scissor to avoid out of bounds access. The coordinate modification engine 502 may output an indicator 512 of the modified set of coordinates of the primitive. In this manner, views may be resolved together such that apps are not configured to use an internal surface layout of a primitive since the driver may program multiple scissors.

In some aspects, a TSE may have a default window scissor for aspects where a single view is used, and an additional five window scissors for aspects where all six primary views are used. The TSE may also accept an enable bit that may toggle when a single window scissor is used, or when all six window scissors are used. For example, if the enable bit is set, then the TSE may use the window scissor multiplexor 506 to select a view based on the indicator 510 of the foveation ID, and perform window scissor clipping with the selected window scissor via the scissoring engine 504 on the set of coordinates indicated by the indicator 508 of the set of coordinates of the primitive. If the enable bit is not set, then the TSE may use a default window scissor to clip primitives.

In some aspects, the coordinate modification engine 502 may have a multiplexor that selectively enables selecting the window scissor using the window scissor multiplexor 506. For example, an enable bit may be set (e.g., multiWindowScissorEnable) when a set of coordinates is to be modified based on a view of a primitive (e.g., by fovID), and may not be set when a set of coordinates is to be modified based on a single global window scissor. This may save resources, as modifying a plurality of sets of coordinates—one for each view of a primitive—may involve fetching each set of coordinates from a plurality of separate sets of registers. However, modifying a single set of coordinates for a single view of a primitive may involve fetching a set of coordinates from a single set of registers. For example, the enable bit may not be set for one hundred draw calls, where each draw call corresponds to a single view of a primitive with a single corresponding window scissor. During those draw calls, the coordinate modification engine 502 may be configured to fetch sets of coordinates from a single set of registers. In another example, the enable bit may be set for three draw calls after the first hundred draw calls where the enable bit was not set, and during those three draw calls the coordinate modification engine 502 may fetch data from more than one set of registers (e.g., six sets of registers, where each set of register stores a set of coordinates for a corresponding primary view of the primitive), so that the coordinate modification engine 502 modifies coordinate data corresponding to each set of registers of the plurality of sets of registers.

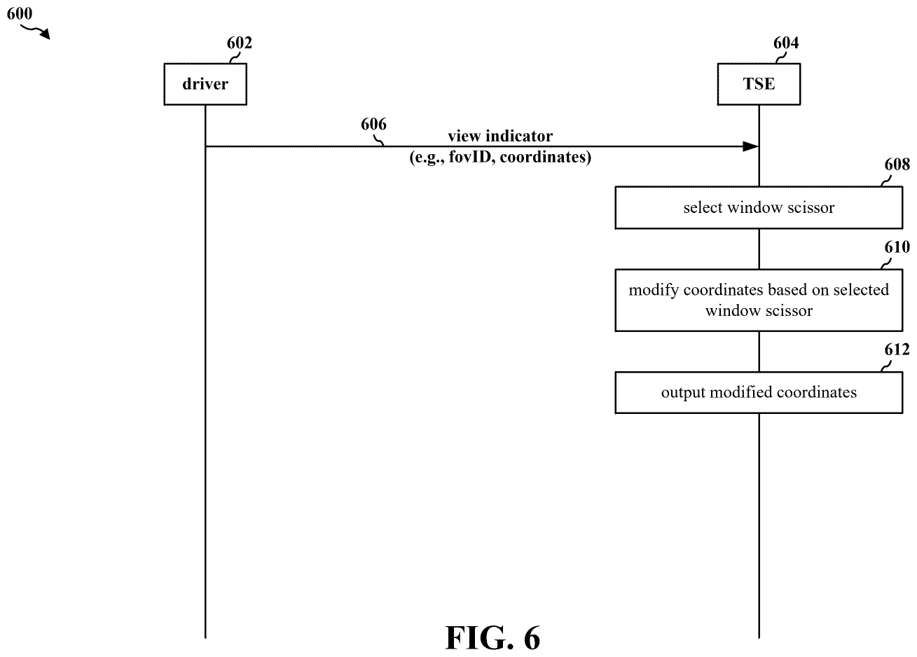

FIG. 6 is a call flow diagram 600 illustrating example communications between a driver 602 and a TSE 604, in accordance with one or more techniques of this disclosure. The driver 602 may be a driver of a graphics processor, such as a GPU. The TSE 604 may be a TSE of a graphics processor, such as a GPU, which may be configured to modify a set of coordinates based on a fovID.

The driver 602 may output a view indicator 606 to the TSE 604. The TSE 604 may obtain the view indicator 606 from the driver 602. In one aspect, the view indicator 606 may include, for example, a bit that indicates that a single window scissor is being used (e.g., the enable bit is not set) and a set of coordinates for a primitive. The view indicator 606 may indicate, to the TSE 604, the number of views and how to select which view to render to. In some aspects, the driver 602 may be configured to calculate the coordinates of each window scissor. Each view may be assigned to an identifier, such as the foveation ID (fovID).

With this information, the TSE 604 may select the correct window scissor to use for the view. At 608, the TSE 604 may select a default window scissor based on the bit that indicates that a single window scissor is being used on the set of coordinates. At 610, the TSE 604 may clip the set of coordinates based on the default window scissor. At 612, the TSE 604 may output an indicator of the set of modified coordinates to the rest of the graphics pipeline. For example, the TSE 604 may output an indication of the set of modified coordinates to the RAS 228 or to a memory location on the graphics processor (i.e., GMEM).

In another aspect, the view indicator 606 may include, for example, a bit that indicates that a plurality of windows scissors (e.g., six window scissors for each of the six primary views of a primitive) are being used, a FovID, and a set of coordinates for a primitive. At 608, the TSE 604 may select a window scissor based on the FovID. At 610, the TSE 604 may clip the set of coordinates based on the window scissor selected at 608. The TSE 604 may then, at 612, output an indicator of the set of modified coordinates to the driver 602.

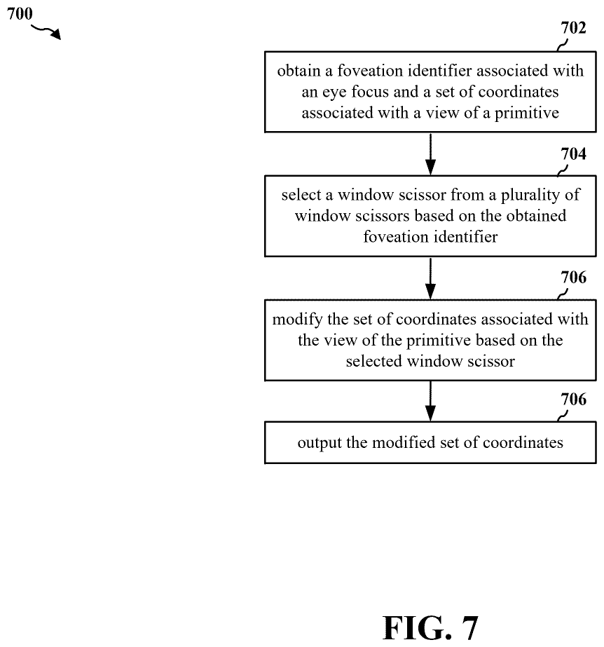

FIG. 7 is a flowchart 700 of an example method of graphics processing in accordance with one or more techniques of this disclosure. The method may be performed by an apparatus, such as an apparatus for graphics processing, a GPU, a CPU, a graphics pipeline, a TSE, a wireless communication device, and the like, as used in connection with the aspects of FIGS. 1-3, 4A-4F, or 5-6.

At 702, the apparatus may obtain a foveation identifier associated with an eye focus and a set of coordinates associated with a view of a primitive. For example, referring to FIGS. 6, 702 may be performed by the TSE 604, which may obtain a view indicator 606 from the driver 602. The view indicator 606 may include a foveation identifier (i.e., fovID) associated with an eye focus of a user. The fovID may indicate a view of a primitive. The view indicator 606 may include a set of coordinates associated with a view of a primitive. In other words, the driver 602 may calculate the coordinates of a primitive, and may provide the coordinates to the TSE 604 for appropriate modification based on the view. In some aspects, an app may select how many views it wants to render of a primitive, provide that data to the driver 602, and the driver 602 may then calculate each set of coordinates for each view, and feed each fovID to the TSE along with each set of coordinates to obtain modified coordinates based on the corresponding view scissors. The driver 602 may calculate the set of coordinates based on at least one of a foveation offset parameter, a shift to an edge of a view parameter, an apron parameter, and/or a merging parameter. Moreover, 702 may be performed by the coordinate modification engine 198 in FIG. 1.

At 704, the apparatus may select a window scissor from a plurality of window scissors based on the obtained foveation identifier. For example, referring to FIGS. 6, 704 may be performed by the TSE 604, which may select a window scissor from a plurality of window scissors based on the obtained foveation identifier. Each window scissor of the plurality of window scissors may be associated with a corresponding view of the primitive. For example, there may be six primary views of the primitive, where each primary view is associated with a corresponding window scissor. The TSE 604 may select the window scissor that corresponds to the primary view that is indicated by the obtained foveation identifier. Where the driver 602 indicates a plurality of foveation identifiers and a corresponding plurality of sets of coordinates, the TSE 604 may independently select each window scissor corresponding to each view based on each foveation identifier of the plurality of foveation identifiers. Moreover, 704 may be performed by the coordinate modification engine 198 in FIG. 1.

At 706, the apparatus may modify the set of coordinates associated with the view of the primitive based on the selected window scissor. For example, referring to FIGS. 6, 706 may be performed by the TSE 604, which may modify the set of coordinates associated with the view of the primitive based on the selected window scissor. This may prevent the set of coordinates from violating an out-of-bounds condition associated with the view of the primitive. Moreover, 706 may be performed by the coordinate modification engine 198 in FIG. 1.

At 708, the apparatus may output the modified set of coordinates. For example, referring to FIGS. 6, 708 may be performed by the TSE 604, which may output the modified set of coordinates. For example, the TSE 604 may save the modified set of coordinates to a GMEM location on a graphics processor. In another example, the TSE 604 may output the modified set of coordinates to a graphics processing engine, for example a stage of a GPU pipeline (e.g., rasterizing stage). A shader of a graphics processor may obtain the output modified set of coordinates. For example, a 3D engine store pass may resolve data stored on a GMEM location to a SYSMEM location in external memory. Moreover, 708 may be performed by the coordinate modification engine 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a foveation identifier associated with an eye focus and a set of coordinates associated with a view of a primitive. The apparatus may further include means for selecting a window scissor from a plurality of window scissors based on the obtained foveation identifier. The apparatus may further include means for modifying the set of coordinates associated with the view of the primitive based on the selected window scissor. The apparatus may further include means for modifying the set of coordinates associated with the view of the primitive based on the selected window scissor. The apparatus may further include means for outputting the modified set of coordinates. The apparatus may further include means for obtaining the output modified set of coordinates at a shader of a graphics processor. The apparatus may further include means for rendering, at the shader, the view of the primitive based on the obtained modified set of coordinates. The apparatus may further include means for obtaining the foveation identifier and the set of coordinates by obtaining the foveation identifier and the set of coordinates from a graphics driver. The apparatus may further include means for selecting the window scissor from the plurality of window scissors based on the obtained foveation identifier by selecting, at a TSE of a graphics processor, the window scissor from the plurality of window scissors. Each window scissor of the plurality of window scissors may be associated with a view of a plurality of views of the primitive. The apparatus may further include means for modifying the set of coordinates associated with the view of the primitive based on the selected window scissor by modifying, at a TSE of a graphics processor, the set of coordinates associated with the view of the primitive based on the selected window scissor. The graphics processor may include a GPU. The apparatus may include the processing unit 120 in FIG. 1. The apparatus may further include means for determining the plurality of views of the primitive based on six primary views of the primitive in space. The apparatus may further include means for determining each window scissor of the plurality of window scissors based on the determined plurality of views before the selection of the window scissor from the plurality of window scissors. The apparatus may further include means for determining each window scissor of the plurality of window scissors based on the determined plurality of views by determining each window scissor of the plurality of window scissors further based on a set of use cases associated with the six primary views of the primitive in space. The apparatus may further include means for obtaining a second foveation identifier associated with a second eye focus and a second set of coordinates associated with a second view of the primitive. The eye focus may be associated with a first eye of a user and the second eye focus is associated with a second eye of the user. The apparatus may further include means for selecting a second window scissor from the plurality of window scissors based on the obtained second foveation identifier. The apparatus may further include means for modifying the second set of coordinates associated with the second view of the primitive based on the selected second window scissor; and outputting the modified second set of coordinates. The apparatus may further include means for obtaining the foveation identifier associated with the eye focus and the set of coordinates associated with the view of the primitive by determining the set of coordinates based on at least one of (a) a foveation offset parameter, (b) a shift to an edge of a view parameter, (c) an apron parameter, or (d) a merging parameter. The apparatus may further include means for outputting the modified set of coordinates by transmitting the modified set of coordinates to a graphics processing engine. The apparatus may further include means for outputting the modified set of coordinates by storing the modified set of coordinates to a second memory.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S ⊆F. Accordingly, each processor of the at least one processor may be configured to perform a particular subset of the set of functions, where the subset is the full set, a proper subset of the set, or an empty subset of the set. A proper subset of a set has one or more elements of the full set, but does not include the full set itself. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.

Aspect 1 is a method of graphics processing, comprising: obtaining a foveation identifier associated with an eye focus and a set of coordinates associated with a view of a primitive; selecting a window scissor from a plurality of window scissors based on the obtained foveation identifier; modifying the set of coordinates associated with the view of the primitive based on the selected window scissor; and outputting the modified set of coordinates.

Aspect 2 is the method of aspect 1, further comprising: obtaining the output modified set of coordinates at a shader of a graphics processor; and rendering, at the shader, the view of the primitive based on the obtained modified set of coordinates.

Aspect 3 is the method of either of aspects 1 or 2, wherein obtaining the foveation identifier and the set of coordinates comprises: obtaining the foveation identifier and the set of coordinates from a graphics driver.

Aspect 4 is the method of any of aspects 1 to 3, wherein selecting the window scissor from the plurality of window scissors based on the obtained foveation identifier comprises: selecting, at a triangle setup engine (TSE) of a graphics processor, the window scissor from the plurality of window scissors, wherein each window scissor of the plurality of window scissors is associated with a view of a plurality of views of the primitive.

Aspect 5 is the method of any of aspects 1 to 4, wherein modifying the set of coordinates associated with the view of the primitive based on the selected window scissor comprises: modifying, at a triangle setup engine (TSE) of a graphics processor, the set of coordinates associated with the view of the primitive based on the selected window scissor.

Aspect 6 is the method of aspect 5, wherein the graphics processor comprises a graphics processing unit (GPU).

Aspect 7 is the method of any of aspects 1 to 6, further comprising: determining the plurality of views of the primitive based on the six primary views of the primitive in space; and determining each window scissor of the plurality of window scissors based on the determined plurality of views before the selection of the window scissor from the plurality of window scissors.

Aspect 8 is the method of aspect 7, wherein determining each window scissor of the plurality of window scissors based on the determined plurality of views comprises: determining each window scissor of the plurality of window scissors further based on a set of use cases associated with the six primary views of the primitive in space.

Aspect 9 is the method of any of aspects 1 to 8, further comprising: obtaining a second foveation identifier associated with a second eye focus and a second set of coordinates associated with a second view of the primitive, wherein the eye focus is associated with a first eye of a user and the second eye focus is associated with a second eye of the user; selecting a second window scissor from the plurality of window scissors based on the obtained second foveation identifier; modifying the second set of coordinates associated with the second view of the primitive based on the selected second window scissor; and outputting the modified second set of coordinates.

Aspect 10 is the method of any of aspects 1 to 9, wherein obtaining the foveation identifier associated with the eye focus and the set of coordinates associated with the view of the primitive comprises: determining the set of coordinates based on at least one of: a foveation offset parameter; a shift to an edge of a view parameter; an apron parameter; or a merging parameter.

Aspect 11 is the method of any of aspects 1 to 10, wherein outputting the modified set of coordinates comprises: transmitting the modified set of coordinates to a graphics processing engine; or storing the modified set of coordinates to a second memory.

Aspect 12 is an apparatus for graphics processing including at least one processor coupled to a memory and configured to implement a method as in any of aspects 1-11.

Aspect 13 may be combined with aspect 12 and includes that the apparatus is a wireless communication device.

Aspect 14 is an apparatus for graphics processing including means for implementing a method as in any of aspects 1-11.

Aspect 15 is a computer-readable medium (e.g., a non-transitory computer-readable medium) storing computer executable code, the code when executed by at least one processor causes the at least one processor to implement a method as in any of aspects 1-11.

Various aspects have been described herein. These and other aspects are within the scope of the following claims.

What is claimed is:

1. An apparatus for graphics processing, comprising:
memory; and
a processor coupled to the memory and, based at least in part on information stored in the memory, the processor is configured to:
obtain a foveation identifier associated with an eye focus and a set of coordinates associated with a view of a primitive;
select a window scissor from a plurality of window scissors based on the obtained foveation identifier;
modify the set of coordinates associated with the view of the primitive based on the selected window scissor; and
output the modified set of coordinates.

2. The apparatus of claim 1, wherein, to output the modified set of coordinates, the processor is configured to:
transmit the modified set of coordinates to a graphics processing engine; or
store the modified set of coordinates to a second memory.

3. The apparatus of claim 1, wherein the processor is further configured to:
obtain the output modified set of coordinates at a shader of a graphics processor; and
render, at the shader, the view of the primitive based on the obtained modified set of coordinates.

4. The apparatus of claim 1, wherein, to obtain the foveation identifier and the set of coordinates, the processor is configured to:
obtain the foveation identifier and the set of coordinates from a graphics driver.

5. The apparatus of claim 1, wherein, to select the window scissor from the plurality of window scissors based on the obtained foveation identifier, the processor is configured to:
select, at a triangle setup engine (TSE) of a graphics processor, the window scissor from the plurality of window scissors, wherein each window scissor of the plurality of window scissors is associated with a view of a plurality of views of the primitive.

6. The apparatus of claim 1, wherein, to modify the set of coordinates associated with the view of the primitive based on the selected window scissor, the processor is configured to:
modify, at a triangle setup engine (TSE) of a graphics processor, the set of coordinates associated with the view of the primitive based on the selected window scissor.

7. The apparatus of claim 6, wherein the graphics processor comprises a graphics processing unit (GPU).

8. The apparatus of claim 1, wherein the processor is further configured to:
determine the plurality of views of the primitive based on six primary views of the primitive in space; and
determine each window scissor of the plurality of window scissors based on the determined plurality of views before the selection of the window scissor from the plurality of window scissors.

9. The apparatus of claim 8, wherein, to determine each window scissor of the plurality of window scissors based on the determined plurality of views, the processor is configured to:
determine each window scissor of the plurality of window scissors further based on a set of use cases associated with the six primary views of the primitive in space.

10. The apparatus of claim 1, wherein the processor is further configured to:
obtain a second foveation identifier associated with a second eye focus and a second set of coordinates associated with a second view of the primitive, wherein the eye focus is associated with a first eye of a user and the second eye focus is associated with a second eye of the user;
select a second window scissor from the plurality of window scissors based on the obtained second foveation identifier;
modify the second set of coordinates associated with the second view of the primitive based on the selected second window scissor; and
output the modified second set of coordinates.

11. The apparatus of claim 1, wherein, to obtain the foveation identifier associated with the eye focus and the set of coordinates associated with the view of the primitive, the processor is configured to:
determine the set of coordinates based on at least one of:
a foveation offset parameter;
a shift to an edge of a view parameter;
an apron parameter; or
a merging parameter.

12. The apparatus of claim 1, wherein the apparatus comprises a wireless communication device.

13. A method of graphics processing, comprising:
obtaining a foveation identifier associated with an eye focus and a set of coordinates associated with a view of a primitive;
selecting a window scissor from a plurality of window scissors based on the obtained foveation identifier;
modifying the set of coordinates associated with the view of the primitive based on the selected window scissor; and
outputting the modified set of coordinates.

14. The method of claim 13, further comprising:
obtaining the output modified set of coordinates at a shader of a graphics processor; and
rendering, at the shader, the view of the primitive based on the obtained modified set of coordinates.

15. The method of claim 13, wherein obtaining the foveation identifier and the set of coordinates comprises:
obtaining the foveation identifier and the set of coordinates from a graphics driver.

16. The method of claim 13, further comprising:
determining the plurality of views of the primitive based on six primary views of the primitive in space; and
determining each window scissor of the plurality of window scissors based on the determined plurality of views before the selection of the window scissor from the plurality of window scissors.

17. The method of claim 16, wherein determining each window scissor of the plurality of window scissors based on the determined plurality of views comprises:
determining each window scissor of the plurality of window scissors further based on a set of use cases associated with the six primary views of the primitive in space.

18. The method of claim 13, further comprising:
obtaining a second foveation identifier associated with a second eye focus and a second set of coordinates associated with a second view of the primitive, wherein the eye focus is associated with a first eye of a user and the second eye focus is associated with a second eye of the user;
selecting a second window scissor from the plurality of window scissors based on the obtained second foveation identifier;
modifying the second set of coordinates associated with the second view of the primitive based on the selected second window scissor; and
outputting the modified second set of coordinates.

19. The method of claim 13, wherein selecting the window scissor from the plurality of window scissors based on the obtained foveation identifier comprises:
selecting, at a triangle setup engine (TSE) of a graphics processor, the window scissor from the plurality of window scissors, wherein each window scissor of the plurality of window scissors is associated with a view of a plurality of views of the primitive.

20. A computer-readable medium storing computer executable code, the code when executed by a processor, causes the processor to:
obtain a foveation identifier associated with an eye focus and a set of coordinates associated with a view of a primitive;
select a window scissor from a plurality of window scissors based on the obtained foveation identifier;
modify the set of coordinates associated with the view of the primitive based on the selected window scissor; and
output the modified set of coordinates.
